(19) United States
(12) Patent Application Publication
(10) Pub. No.: US 2021/0163133 A1
(43) Pub. Date: Jun. 3, 2021

(54) COMPENSATION METHOD FOR BAROMETER-BASED HEIGHT MEASUREMENT AND UAV

(71) Applicant: SZ DJI TECHNOLOGY CO., LTD., Shenzhen (CN)

(72) Inventor: Yongkang TAO, Shenzhen (CN)

(21) Appl. No.: 17/149,118

(22) Filed: Jan. 14, 2021

Related U.S. Application Data
(63) Continuation of application No. PCT/CN2018/097617, filed on Jul. 27, 2018.

(51) Int. Cl. B64C 39/02; G05D 1/04; G01C 5/06

(52) U.S. Cl. CPC B64C 39/024; B64C 2201/141; G01C 5/06; G05D 1/044

(57) ABSTRACT

A compensation method for barometer-based height measurement includes obtaining a flight speed of an unmanned aerial vehicle (UAV) in response to a change of a motion state of the UAV, determining a flight height compensation value corresponding to the flight speed of the UAV according to a predetermined corresponding relationship between flight speeds and flight height compensation values, and, during a process of changing the motion state, compensating a flight height detected by a barometer of the UAV according to the flight height compensation value.

### CROSS-REFERENCE TO RELATED APPLICATION

This application is a continuation of International Application No. PCT/CN2018/097617, filed on Jul. 27, 2018, the entire content of which is incorporated herein by reference.

### TECHNICAL FIELD

The present disclosure relates to the technical field of unmanned aerial vehicle (UAV) and, more particularly, to a compensation method for barometer-based height measurement and a UAV.

### BACKGROUND

During a flight of an unmanned aerial vehicle (UAV), in order to accurately control the flight of the UAV, satisfy a height limit requirement of the UAV, and ensure a flight safety of the UAV, the flight height of the UAV needs to be detected. Taking satisfying the height limit requirement of UAV as an example, if the flight height of the UAV is too high, the UAV is affected and prone to safety accidents, such that the flight height of the UAV needs to be limited. Therefore, during the flight of the UAV, the flight height of the UAV is detected, and when the flight height of the UAV is greater than a limited height, the UAV is limited from continuous flying upwards to ensure that the flight height of the UAV is less than or equal to the limited height.

In conventional technologies, a barometer is generally provided in the UAV, and the flight height of the UAV is detected by the barometer. For example, the barometer detects a current air pressure. Since there is a corresponding relationship between the air pressure and a height, the height corresponding to the current air pressure is obtained according to the corresponding relationship, and the obtained height is the flight height of the UAV.

However, when the UAV is braking, changes of a speed of a propeller of the UAV within a short period of time causes changes in a surrounding airflow environment and fluctuations between the air pressure value detected by the barometer and the actual air pressure value, thereby resulting in an inaccurate height detection, which easily causes the UAV to drop or rise when braking.

### SUMMARY

In accordance with the disclosure, there is provided a compensation method for barometer-based height measurement including obtaining a flight speed of an unmanned aerial vehicle (UAV) in response to a change of a motion state of the UAV, determining a flight height compensation value corresponding to the flight speed of the UAV according to a predetermined corresponding relationship between flight speeds and flight height compensation values, and, during a process of changing the motion state, compensating a flight height detected by a barometer of the UAV according to the flight height compensation value.

Also in accordance with the disclosure, there is provided an unmanned aerial vehicle (UAV) including a barometer configured to detect a flight height of the UAV and a processor configured to obtain a flight speed of the UAV in response to a change of a motion state of the UAV, determine a flight height compensation value corresponding to the flight speed of the UAV according to a predetermined corresponding relationship between flight speeds and the height compensation values, and, during a process of changing the motion state, compensate the flight height detected by the barometer according to the flight height compensation value.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples and other drawings conceived by those having ordinary skills in the art on the basis of the described drawings without inventive efforts should fall within the scope of the present disclosure.

FIG. 1 is a schematic architecture diagram of an unmanned aerial system consistent with embodiments of the disclosure.

FIG. 2 is a schematic flowchart of a compensation method for barometer-based height measurement consistent with embodiments of the disclosure.

FIG. 3 is a schematic flowchart showing predetermination of a corresponding relationship between flight speeds and height compensation values consistent with embodiments of the disclosure.

FIG. 4 is a schematic structural diagram of an unmanned aerial vehicle (UAV) consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connected to” a second component, it is intended that the first component may be directly connected to the second component or may be indirectly connected to the second component via another component.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any and all suitable combinations of one or more related items listed.

Hereinafter, example embodiments will be described with reference to the accompanying drawings. Unless conflicted, the features of the following embodiments and implementations can be combined with each other.

The present disclosure provides a compensation method for barometer-based height measurement and an unmanned aerial vehicle (UAV). The UAV may include a rotorcraft, for example, a multi-rotor aircraft propelled by multiple propulsion devices through the air, which is not limited herein.

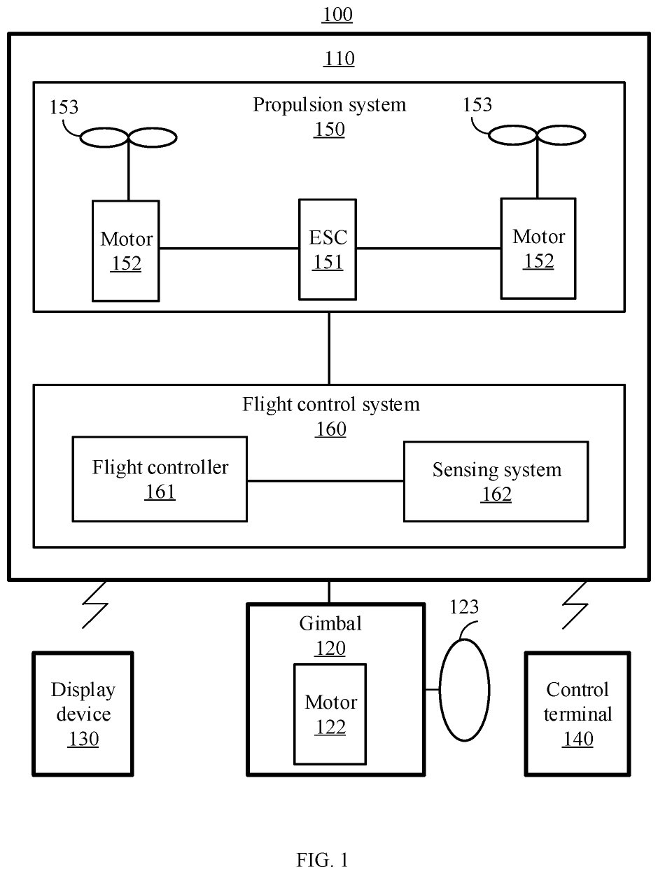

FIG. 1 is a schematic architecture diagram of an example unmanned aerial system 100 consistent with the disclosure. Herein, a rotor UAV is taken as an example.

As shown in FIG. 1, the unmanned aerial system 100 includes an unmanned aerial vehicle (UAV) 110, a display device 130, and a control terminal 140. The UAV 110 includes a propulsion system 150, a flight control system 160, a frame, and a gimbal 120 arranged at the frame. The UAV 110 can be configured to wirelessly communicate with the control terminal 140 and the display device 130.

The frame can include a body and a stand (also referred to as a landing gear). The body may include a center frame and one or more arms connected to the center frame, and the one or more arms can extend radially from the center frame. The stand can be connected to the body and configured to support the UAV 110 when the UAV 10 is landed.

The propulsion system 150 includes one or more electronic speed controls 151 (also referred to as ESCs), one or more propellers 153, and one or more motors 152 corresponding to the one or more propellers 153. The one or more motors 152 can be connected between the one or more electronic speed controls 151 and the one or more propellers 153, and the one or more motors 152 and the one or more propellers 153 can be arranged at the one or more arms of the UAV 110. The one or more electronic speed controls 151 can be configured to receive driving signals generated by the flight control system 160 and provide driving currents to the one or more motors 152 according to the driving signals to control rotation speeds of the one or more motors 152. The one or more motors 152 can be configured to drive the one or more propellers to rotate, so as to provide a power for the flight of the UAV 110, and the power can enable the UAV 110 to achieve one or more degrees of freedom of movement. In some embodiments, the UAV 110 may rotate around one or more rotation axes. For example, the one or more rotation axes may include a roll axis, a yaw axis, and a pitch axis. The one or more motors 152 may include one or more direct current (DC) motors or one or more alternating current (AC) motors. In addition, the one or more motors 152 may include one or more brushless motors or one or more brushed motors.

The flight control system 160 includes a flight controller 161 and a sensing system 162. The sensing system 162 can be configured to measure attitude information of the UAV 110, e.g., position information and state information of the UAV 110 in space, such as three-dimensional (3D) position, 3D angle, 3D velocity, 3D acceleration, 3D angular velocity, and the like. The sensing system 162 may include, for example, at least one of a gyroscope, an ultrasonic sensor, an electronic compass, an inertial measurement unit (IMU), a vision sensor, a global navigation satellite system, a barometer, or another sensor. For example, the global navigation satellite system may include a global positioning system (GPS). The flight controller 161 can be configured to control the flight of the UAV 110, for example, control the flight of the UAV 110 according to the attitude information measured by the sensor system 162. The flight controller 161 can control the UAV 110 according to pre-programmed program instructions, and can also control the UAV 110 by responding to one or more control instructions from the control terminal 140.

The gimbal 120 includes a motor 122. The gimbal can be configured to carry a shooting device 123. The flight controller 161 can control a movement of the gimbal 120 through the motor 122. In some embodiments, the gimbal 120 may further include a controller configured to control the movement of the gimbal 120 by controlling the motor 122. The gimbal 120 may be independent of the UAV 110 or may be a portion of the UAV 110. The motor 122 may include a DC motor or an AC motor. In addition, the motor 122 may include a brushless motor or a brushed motor. The gimbal may be located on a top of the UAV 110 or on a bottom of the UAV 110.

The shooting device 123 may include, for example, a device for capturing images, such as a camera or a video camera, and the shooting device 123 may be configured to communicate with the flight controller 161 and shoot images under the control of the flight controller 161. The shooting device 123 can include at least a photosensitive element, and the photosensitive element can include, for example, a Complementary Metal Oxide Semiconductor (CMOS) sensor or a Charge-coupled Device (CCD) sensor. In some embodiments, the camera 123 can be directly fixed at the UAV 110, and the gimbal 120 can be omitted.

The display device 130 can be arranged at a ground terminal of the UAV 100, and configured to communicate with the UAV 110 in a wireless manner and display the attitude information of the UAV 110. In some embodiments, the image shot by the shooting device 123 may be displayed on the display device 130. The display device 130 may include an independent device or may be integrated in the control terminal 140.

The control terminal 140 can be arranged at the ground end of the UAV 100, and can be configured to communicate with the UAV 110 in a wireless manner for remote control of the UAV 110.

The UAV 110 may further include a speaker (not shown), and the speaker can be configured to play audio files. The speaker can be directly fixed at the UAV 110 or mounted at the gimbal 120.

The naming of the components of the unmanned aerial system 100 is merely for identification, and not intended to limit the present disclosure.

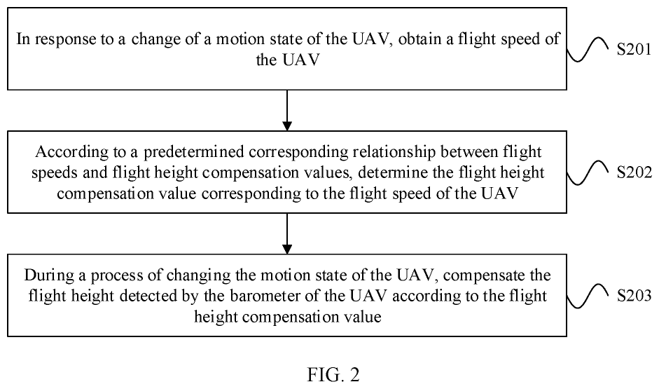

FIG. 2 is a schematic flowchart of an example compensation method for barometer-based height measurement consistent with the disclosure. The method can be applicable to an UAV.

As shown in FIG. 2, at 201, in response to a change of a motion state (a motion state change) of the UAV, a flight speed of the UAV is obtained.

In some embodiments, the change of the motion state of the UAV may include at least one of a change of a flight direction of the UAV or a change of the flight speed of the UAV. The change of the motion state of the UAV can be caused by an internal power output of the UAV. For example, a change of a joystick amount received by the UAV can cause the internal power output of the UAV to change, thereby causing the change of the flight direction and/or flight speed of the UAV. The change of the motion state of the UAV can be caused by an external power of the UAV. For example, wind can cause the flight direction of the UAV to change, or wind can cause the flight speed of the UAV to increase or decrease. In an application scenario (e.g., the UAV is braking), when the UAV is braking, the joystick amount received by the UAV can change to cause the flight speed of the UAV along a current flight direction to decrease continuously, which belongs to the change of the motion state of the UAV.

If the motion state of the UAV changes, a speed of a propeller of the UAV can change, thereby causing a surrounding airflow environment to change. A fluctuation can be caused between an air pressure value detected by the barometer and an actual air pressure value, thereby causing a flight height of the UAV detected by the barometer to be inaccurate, and thus the flight height detected by the barometer needs to be compensated. Therefore, when the motion state of the UAV changes, the UAV can obtain the flight speed of the UAV. In some embodiments, the flight speed may include a speed vector, e.g., the flight speed can include a direction of the flight speed and a magnitude of the flight speed.

At S202, according to a predetermined corresponding relationship between flight speeds and flight height compensation values, a flight height compensation value corresponding to the flight speed of the UAV is determined.

In some embodiments, after obtaining the flight speed of the UAV, the UAV can determine the flight height compensation value corresponding to the flight speed of the UAV obtained at S201 according to the predetermined corresponding relationship between the flight speeds and the flight height compensation values.

At S203, during a process of the change of the motion state of the UAV, the flight height detected by the barometer of the UAV is compensated according to the flight height compensation value.

In some embodiments, after the UAV obtains the flight height compensation value corresponding to the flight speed, during the process of the change of the motion state of the UAV, the flight height detected by the barometer of the UAV can be compensated according to the flight height compensation value. As such, an error between the flight height detected by the barometer and the actual flight height caused by the change in the airflow environment around the UAV in response to the change of the motion state of the UAV can be compensated. In some embodiments, the flight height compensation value may include a positive value or a negative value.

Consistent with the disclosure, the compensation method for barometer-based height measurement can obtain the flight speed of the UAV when the motion state of the UAV changes. According to the predetermined corresponding relationship between the flight speeds and the flight height compensation values, the flight height compensation value corresponding to the flight speed of the UAV can be determined. During the process of the change of the motion state of the UAV, the flight height detected by the barometer of the UAV can be compensated in real time according to the flight height compensation value. Therefore, an accuracy of the barometer to detect the flight height can be improved, and a phenomenon that the change of the motion state of the UAV causing a drop or rise of the UAV can be avoided.

In some embodiments, after the UAV obtains the flight height compensation value, during the process of the change of the motion state of the UAV, a product of the flight height compensation value and a flight height compensation coefficient can be superimposed to the flight height detected by the barometer to obtain a compensated flight height. For example, H′(t)=H(t)+ΔH*α, wherein H′(t) represents the compensated flight height at time t, H represents the flight height detected by the barometer at time t, ΔH represents the compensated flight height, α represents the flight height compensation coefficient. For example, α can include a positive value, a negative value, or a preset fixed value. In some embodiments, whether α has the positive or negative value can be determined according to whether the change of the motion state of the UAV is acceleration or deceleration. For example, it is assumed that the flight height compensation value has the positive value. If the motion state of the UAV is deceleration, α can have the positive value. If the motion state of the UAV is acceleration, α can have the negative value. The present disclosure is not limited herein. In some embodiments, when α is equal to 1, the flight height compensation value can be directly superimposed on the flight height detected by the barometer of the UAV.

In some embodiments, after the UAV obtains the flight height compensation value, during the process of the change of the motion state of the UAV, the flight height compensation coefficient can be determined according to a duration of the change of the motion state of the UAV, and the product of the flight height compensation value and the flight height compensation coefficient can be superimposed on the flight height detected by the barometer to obtain the compensated flight height. In some embodiments, after the UAV obtains the flight height compensation value, as the duration of the change of the motion state of the UAV increases, the flight height compensation coefficient can be determined in real time. The flight height compensation coefficient can be no longer fixed to a value, but related to the duration of the change of the motion state of the UAV. For example, at a current time, the duration of the change of the motion state of the UAV can be determined, the flight height compensation coefficient corresponding to the current time can be determined according to the duration, and the product of the flight height compensation coefficient and the flight height value corresponding to the current time can be superimposed to the flight height detected by the barometer. For example, H′(t)=H(t)+ΔH*α[T(t)], wherein H′(t) represents the compensated flight height at time t, H represents the flight height detected by the barometer at time t, ΔH represents the compensated flight height, T(t) represents the duration of the change of the motion state of the UAV, α represents the flight height compensation coefficient, and the value of α can be related to T(t).

In some embodiments, as the duration of the change of the motion state of the UAV continues to increase, the corresponding flight height compensation coefficient can continue to change. For example, the flight height compensation coefficient can have a linear relationship with the duration of the change of the motion state of the UAV. Assume that a total duration for the change of the motion state of the UAV is 10 seconds, the flight height compensation coefficient can continuously change from 0 to 1 within 0 to 10 seconds. When the UAV motion state changes for 1 second, the corresponding flight height compensation coefficient can be 1. According to the flight height compensation coefficient of 1 and the flight height compensation value, the flight height detected by the barometer can be compensated. When the UAV motion state changes for 5 second, the corresponding flight height compensation coefficient can be 0.5. According to the flight height compensation coefficient of 0.5 and the flight height compensation value, the flight height detected by the barometer can be compensated.

In some embodiments, as the duration of the change of the motion state of the UAV continues to increase, the flight height can be compensated differently in different time periods. For example, the corresponding flight height compensation coefficient can be consistent for a period of time when the motion state of the UAV changes. Assume that the total duration for the change of the motion state of the UAV is 10 seconds, when the change of the motion state of the UAV is within 0 to 2 seconds, the corresponding flight height compensation coefficient can be 1. During the 0 to 2 seconds period of time, according to the flight height compensation coefficient of 1 and the flight height compensation value, the flight height detected by the barometer during this period can be compensated. When the change of the motion state of the UAV is within 2 to 4 seconds, the corresponding flight height compensation coefficient can be 0.8. During the 2 to 4 seconds period of time, according to the flight height compensation coefficient of 0.8 and the flight height compensation value, the flight height detected by the barometer during this period can be compensated. The similar description will be omitted herein.

In some embodiments, as the duration of the change of the motion state of the UAV continues to increase, the flight height can be compensated in two manners. During an early period of the duration when the motion state of the UAV changes, the product of a first flight height compensation coefficient and the flight height compensation value can be superimposed on the flight height detected by the barometer to obtain the compensated flight height. During a later period of the duration when the motion state of the UAV changes, the product of a second flight height compensation coefficient and the flight height compensation value can be superimposed on the flight height detected by the barometer to obtain the compensated flight height. The first flight height compensation coefficient can be different from the second flight height compensation coefficient.

For example, the first flight height compensation coefficient can be 1, and the second flight height compensation coefficient can be 0.5. During the early period of the duration when the motion state of the UAV changes, the UAV may superimpose the flight height compensation value on the flight height detected by the barometer. During the later period of the duration when the motion state of the UAV changes, 0.5 times the flight height compensation value can be superimposed on the flight height detected by the barometer. In some embodiments, the early period of duration may be within a preset time (e.g., 3 seconds) after the motion state of the UAV starts to change, and the later period of duration may be, for example, the period of time during which the motion state of the UAV changes after the 3 seconds. In some embodiments, the early period of duration may be, for example, the early 30% of the duration of the change of the motion state of the UAV, and the later period of duration may be, for example, the later 70% of the duration of the change of the motion state of the UAV. The values described above are merely examples and not intended to limit the disclosure.

Therefore, when the motion state of the UAV changes, instead of always compensating a fixed value to the flight height detected by the barometer, different compensation values can be used during the process of the change of the motion state, thereby compensating for different height changes caused by the drop or rise of the UAV. As such, the compensated flight height of the UAV during the change of the motion state of the UAV can be closer to the actual flight height of the UAV.

In some embodiments, if the motion state of the UAV stops changing, the compensation for the flight height detected by the barometer can be stopped. Because when the motion state of the UAV remains unchanged, the airflow environment around the UAV can also remain unchanged and cannot interfere with the barometer. Thus, the flight height detected by the barometer can be very close to the actual flight height, and there is no need to compensate the flight height detected by the barometer. For example, a stop of the change of the motion state of the UAV may include that the flight speed of the UAV drops to zero, or the flight speed of the UAV remains unchanged. In some embodiments, if the application is the flight height compensation during the braking process of the UAV, the change of the motion state of the UAV can include the braking of the UAV. Thus, the stop of the change of the motion state of the UAV can include the flight speed of the UAV drops to 0, or the UAV receives the joystick amount during braking.

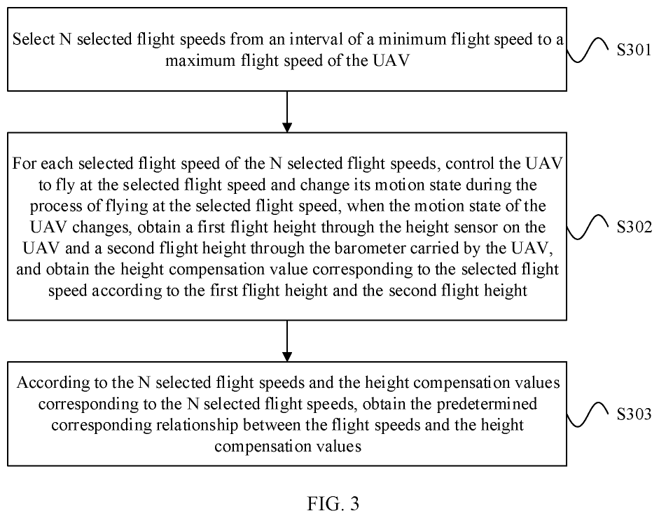

In some embodiments, before performing the processes described above, the UAV can further obtain the predetermined corresponding relationship between the flight speeds and the flight height compensation values. For example, the UAV may predetermine the corresponding relationship and save the corresponding relationship. As another example, the corresponding relationship may be determined by another device in advance, and then the UAV can obtain and save the corresponding relationship from the another device. Hereinafter, the corresponding relationship being predetermined in advance by the UAV is described as an example. FIG. 3 is a schematic flowchart of predetermining the corresponding relationship between the flight speeds and the height compensations consistent with the disclosure.

As shown in FIG. 3, at S301, N selected flight speeds are selected from a minimum flight speed to a maximum flight speed of the UAV.

In some embodiments, the UAV can select N flight speeds from the minimum flight speed to the maximum flight speed of the UAV as the N selected flight speeds. The N selected flight speeds can be different from each other, and each selected flight speed can fall within a range of the minimum flight speed to the maximum flight speed.

In some embodiments, the UAV can divide a speed interval of the minimum flight speed to the maximum flight speed into N flight speed segments, and obtain the N selected flight speeds by selecting one selected flight speed from each flight speed segment. Assume that the minimum flight speed of the UAV is 0 m/s, the maximum flight speed is 20 m/s, and N is 5, then 5 selected flight speeds can be selected from 0 m/s to 20 m/s. Divide the speed interval of 0 m/s to 20 m/s into 5 flight speed sections, e.g., 0 m/s to 4 m/s flight speed section, 4 m/s to 8 m/s flight speed section, 8 m/s to 12 m/s flight speed section, 12 m/s to 16 m/s flight speed section, and 16 m/s to 20 m/s flight speed section. A selected flight speed from the 0 m/s to 4 m/s flight speed section (e.g., a middle value in the flight speed section, for example, 2 m/s) can be selected. A selected flight speed from the 4 m/s to 8 m/s flight speed section (e.g., a middle value in the flight speed section, for example, 6 m/s) can be selected. A selected flight speed from the 8 m/s to 12 m/s flight speed section (e.g., a middle value in the flight speed section, for example, 10 m/s) can be selected. A selected flight speed from the 12 m/s to 16 m/s flight speed section (e.g., a middle value in the flight speed section, for example, 14 m/s) can be selected. A selected flight speed from the 16 m/s to 20 m/s flight speed section (e.g., a middle value in the flight speed section, for example, 18 m/s) can be selected. A total of 5 selected flight speeds of 2 m/s, 6 m/s, 10 m/s, 14 m/s, and 18 m/s can be obtained.

At S302, for each selected flight speed of the N selected flight speeds, the UAV is controlled to fly at the selected flight speed, the UAV is controlled to change its motion state during the process of the UAV flying at the selected flight speed, when the motion state of the UAV changes, a first flight height is obtained through the height sensor on the UAV, and a second flight height is obtained through the barometer carried by the UAV, and the flight height compensation value corresponding to the selected flight speed is obtained according to the first flight height and the second flight height.

Takes the 5 selected flight speeds described above as an example, the UAV can be controlled to fly at 2 m/s, and to change its motion state during the flight at 2 m/s. For example, the UAV can be controlled to decelerate (e.g., brake) or accelerate from 2 m/s. When the motion state of the UAV changes, the first flight height can be obtained through the height sensor carried by the UAV, and the second flight height can be obtained through the barometer carried by the UAV. The flight height compensation value corresponding to 2 m/s can be obtained according to the first flight height and the second flight height. Using the same method described above, the flight height compensation value corresponding to 6 m/s, the flight height compensation value corresponding to 10 m/s, the flight height compensation value corresponding to 14 m/s, and the flight height compensation value corresponding to 18 m/s can be further obtained.

At S303, according to the N selected flight speeds and the flight height compensation values corresponding to the N selected flight speeds, the predetermined corresponding relationship between the flight speeds and the flight height compensation values is obtained.

For example, after obtaining the flight height compensation value corresponding to 2 m/s, the flight height compensation value corresponding to 6 m/s, the flight height compensation value corresponding to 10 m/s, the flight height compensation value corresponding to 14 m/s, and the flight height compensation value corresponding to 18 m/s, according to the flight height compensation value corresponding to 2 m/s and the flight speed 2 m/s, the flight height compensation value corresponding to 6 m/s and the flight speed 6 m/s, the flight height compensation value corresponding to 10 m/s and the flight speed 10 m/s, the height corresponding to 14 m/s and the flight speed 14 m/s, the flight height compensation value corresponding to 18 m/s and the flight speed 18 m/s, the corresponding relationship between the flight speeds and the flight height compensation values can be obtained.

In some embodiments, the UAV may perform a fitting processing on the N selected flight speeds and the flight height compensation values corresponding to the N selected flight speeds to obtain the corresponding relationship between the flight speeds and the flight height compensation values. For example, the UAV can perform the fitting on the flight height compensation value for 2 m/s and the flight speed 2 m/s, the flight height compensation value for 6 m/s and the flight speed 6 m/s, the flight height compensation value for 10 m/s and the flight speed 10 m/s, the flight height compensation value for 14 m/s and the flight speed 14 m/s, and the flight height compensation value for 18 m/s and the flight speed 18 m/s to obtain the corresponding relationship between the flight speeds and the flight height compensation values.

In some embodiments, the fitting process can be as follows. For every two adjacent selected flight speeds among the N selected flight speeds, the UAV can perform a linear interpolation processing according to the two adjacent selected flight speeds and the two height compensation values corresponding to the two adjacent selected flight speeds to obtain the corresponding relationship between the two adjacent selected flight speeds and height compensation values. According to the corresponding relationship between every two adjacent selected flight speeds among the N selected flight speeds and the flight height compensation values, the predetermined corresponding relationship between the flight speeds and the flight height compensation values can be obtained. For example, the UAV can perform the linear interpolation processing on the flight height compensation values corresponding to 2 m/s and the flight speed 2 m/s, and the flight height compensation values corresponding to 6 m/s and the flight speed 6 m/s to obtain the corresponding relationship between the flight speeds from 2 m/s to 6 m/s and height compensation values. The UAV can perform the linear interpolation processing on the flight height compensation values corresponding to 6 m/s and the flight speed 6 m/s, and the flight height compensation values corresponding to 10 m/s and the flight speed 10 m/s to obtain the corresponding relationship between the flight speeds from 6 m/s to 10 m/s and the flight height compensation values. The UAV can perform the linear interpolation processing on the flight height compensation values corresponding to 10 m/s and the flight speed 10 m/s, and the flight height compensation values corresponding to 14 m/s and the flight speed 14 m/s to obtain the corresponding relationship between the flight speeds from 10 m/s to 14 m/s and height compensation values. The UAV can perform the linear interpolation processing on the flight height compensation values corresponding to 14 m/s and the flight speed 14 m/s, and the flight height compensation values corresponding to 18 m/s and the flight speed 18 m/s to obtain the corresponding relationship between the flight speeds from 14 m/s to 18 m/s and height compensation values. The UAV can obtain the corresponding relationship between the flight speeds from 0 m/s to 20 m/s, according to the corresponding relationship between the flight speeds from 2 m/s to 6 m/s and height compensation values, the corresponding relationship between the flight speeds from 6 m/s to 10 m/s and the flight height compensation values, the corresponding relationship between the flight speeds from 10 m/s to 14 m/s and height compensation values, and the corresponding relationship between the flight speeds from 14 m/s to 18 m/s and height compensation values.

In some embodiments, the flight speed of the UAV can include the speed vector including the direction of the flight speed (e.g., the flight direction) and the magnitude of the flight speed.

In some embodiments, the predetermined corresponding relationship between the flight speeds and the flight height compensation values can include the predetermined corresponding relationship between the magnitudes of the flight speeds and the flight height compensation values in each of four preset flight directions. The four preset flight directions can include a front direction relative to a nose, a rear direction relative to the nose, a left direction relative to the nose, and a right direction relative to the nose of the UAV. The predetermined corresponding relationship between the magnitudes of the flight speeds and the flight height compensation values under each preset flight direction can be obtained by performing the processes at S301 to S303, and the detailed description thereof will be omitted herein. For each preset flight direction, when the processes at S301 is executed, the minimum flight speed and the maximum flight speed corresponding to the preset flight direction can be used. The minimum flight speeds corresponding to different preset flight directions may be different, and the maximum flight speeds corresponding to different preset flight directions may be different.

The predetermined corresponding relationship between the flight speeds and height compensation values can include the predetermined corresponding relationship between the flight speeds and the flight height compensation values when the flight direction is the front direction relative to the nose of the UAV, the predetermined corresponding relationship between the flight speeds and the height compensations value when the flight direction is the rear direction relative to the nose of the UAV, the predetermined corresponding relationship between the flight speeds and the flight height compensation values when the flight direction is the left direction relative to the nose of the UAV, the predetermined corresponding relationship between the flight speeds and the flight height compensation values when the flight direction is the right direction relative to the nose of the UAV.

If the flight direction of the UAV obtained at S201 is the front direction relative to the nose of the UAV, the UAV can determine the flight height compensation value according to the corresponding relationship between the flight speeds and the flight height compensation values when the flight direction is the front direction relative to the nose of the UAV.

If the flight direction of the UAV obtained at S201 is a front-left direction of the UAV, the UAV can obtain a magnitude of a flight speed component along the front direction relative to the nose of the UAV and a magnitude of a flight speed component along the left direction relative to the nose of the UAV according to the flight speed. According to the magnitude of the flight speed component along the front direction relative to the nose of the UAV and the corresponding relationship between the magnitude of the flight speed components along the front direction relative to the nose of the UAV and the flight height compensation values, the flight height compensation value corresponding to the front direction relative to the nose can be determined. According to the magnitude of the flight speed component along the left direction relative to the nose of the UAV and the corresponding relationship between the magnitude of the flight speed components along the left direction relative to the nose of the UAV and the flight height compensation values, the flight height compensation value corresponding to the left direction relative to the nose can be determined. The flight height compensation value can be obtained according to the magnitude of the flight speed component along the front direction relative to the nose of the UAV and the magnitude of the flight speed component along the left direction relative to the nose of the UAV. For example, the flight height compensation value can be obtained by adding the flight height compensation value corresponding to the front direction relative to the nose and the flight height compensation value corresponding to the left direction relative to the nose.

In some embodiments, the predetermined corresponding relationship between the flight speeds and the flight height compensation values can include the predetermined corresponding relationship between the flight speeds and the flight height compensation values corresponding to increasing of the flight speed, and the predetermined corresponding relationship between the flight speeds and the flight height compensation values corresponding to decreasing of the flight speed (e.g., braking). In some embodiments, when the change of the motion state of the UAV includes the increasing of the speed of the UAV, the UAV can determine the flight height compensation value according to the speed of the UAV and the predetermined corresponding relationship between the flight speeds and the flight height compensation values corresponding to the increasing of the flight speed. In some embodiments, when the change of the motion state of the UAV includes the decreasing of the speed of the UAV, the UAV can determine the flight height compensation value according to the speed of the UAV and the predetermined corresponding relationship between the flight speeds and the flight height compensation values corresponding to the decreasing of the flight speed. In some embodiments, when the change of the motion state of the UAV includes deceleration of the UAV in a first direction and acceleration of the UAV in a second direction, the UAV can determine the flight height compensation value corresponding to the first direction according to the flight speed in the first direction and the predetermined corresponding relationship between the flight speeds and the flight height compensation values corresponding to the decreasing of the flight speed, determine the flight height compensation value corresponding to the second direction according to the flight speed in the second direction and the predetermined corresponding relationship between the flight speeds and the flight height compensation values corresponding to the increasing of the flight speed, and determine the flight height compensation value according to the flight height compensation value corresponding to the first direction and the flight height compensation value corresponding to the second direction.

In some embodiments, when the motion state of the UAV changes, the obtained flight speed of the UAV can include the flight speed before the motion state of the UAV changes. When determining the flight height compensation value, the UAV can determine the flight height compensation value according to the flight speed before the motion state of the UAV changes and the predetermined corresponding relationship between the flight speeds and the flight height compensation values.

In some embodiments, if the predetermined corresponding relationship between the flight speeds and the flight height compensation values includes the predetermined corresponding relationship between the flight speeds and the flight height compensation values corresponding to the increasing of the flight speed, and the predetermined corresponding relationship between the flight speeds and the flight height compensation values corresponding to the decreasing of the flight speed, the flight speed of the UAV obtained by the UAV can include the flight speed after the motion state of the UAV changes. The motion state of the UAV can be determined as acceleration or decreasing according to the flight speed before the motion state of the UAV changes and the flight speed after the change. Then the UAV can determine the flight height compensation value according to the flight speed before the motion state of the UAV changes and the predetermined corresponding relationships between the flight speeds and the flight height compensation values corresponding to the increasing or deceleration of the flight speed.

In some embodiments, the predetermined corresponding relationship between the flight speeds and the flight height compensation values corresponding to the increasing of the flight speed can be obtained using the processes at S301 to S303, and detailed description thereof will be omitted herein. The change of the motion state at S302 described above can refer to the acceleration of the UAV. For example, for each selected flight speed of the N selected flight speeds, the UAV can be controlled to fly at the selected flight speed and to accelerate during the process of the UAV flying at the selected flight speed, when the UAV is accelerating, the first flight height can be obtained through the height sensor carried by the UAV, and the second flight height can be obtained through the barometer carried by the UAV, and the flight height compensation value corresponding to the selected flight speed can be obtained according to the first flight height and the second flight height.

In some embodiments, the predetermined corresponding relationship between the flight speeds and the flight height compensation values corresponding to the deceleration of the flight speed can be obtained using the processes at S301 to S303, and detailed description thereof will be omitted herein. The change of the motion state at S302 described above can refer to the deceleration of the UAV.

In some other embodiments, the predetermined corresponding relationship between the flight speeds and the flight height compensation values corresponding to the deceleration of the flight speed can be obtained using the processes at S301 to S303, and detailed description thereof will be omitted herein. The change of the motion state at S302 described above can refer to the deceleration of the UAV. For example, for each selected flight speed of the N selected flight speeds, the UAV can be controlled to fly at the selected flight speed and to decelerate (e.g., braking) during the process of the UAV flying at the selected flight speed, when the UAV is decelerating, the first flight height can be obtained through the height sensor carried by the UAV, and the second flight height can be obtained through the barometer carried by the UAV, the flight height compensation value corresponding to the selected flight speed can be obtained according to the first flight height and the second flying height.

In some embodiments, if the change of the motion state of the UAV at 201 includes the deceleration of the UAV, the UAV can determine the flight height compensation value according to the flight speed of the UAV and the predetermined corresponding relationship between the flight speeds and the flight height compensation values, and according to the flight height compensation value and the flight height compensation coefficient corresponding to the deceleration, the flight height detected by the barometer can be compensated. For example, the flight height compensation coefficient corresponding to deceleration can include a positive value, and the flight height compensation coefficient corresponding to acceleration can include a negative value.

In some other embodiments, the predetermined corresponding relationship between the flight speed and the flight height compensation value can be obtained using the processes at S301 to S303, and detailed description thereof will be omitted herein. The change of the motion state at S302 can refer to the acceleration of the UAV.

In some embodiments, if the change of the motion state of the UAV includes the acceleration of the UAV, the UAV can determine the flight height compensation value according to the flight speed of the UAV and the predetermined corresponding relationship between the flight speeds and the flight height compensation values, and according to the flight height compensation value and the flight height compensation coefficient corresponding to the acceleration, the flight height detected by the barometer can be compensated. For example, the flight height compensation coefficient corresponding to deceleration can include the positive value, and the flight height compensation coefficient corresponding to acceleration can include the negative value.

The present disclosure further provides a computer storage medium. The computer storage medium can store program instructions, when being executed, some or all of the processes of the compensation method for barometer-based height measurement consistent with the disclosure (e.g., the compensation method for barometer-based height measurement in FIG. 2) can be performed.

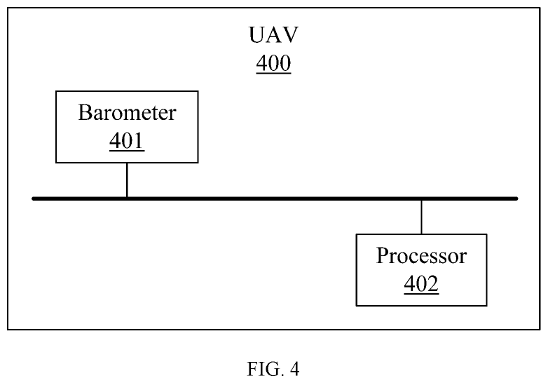

FIG. 4 is a schematic structural diagram of an example UAV 400 consistent with embodiments of the disclosure. As shown in FIG. 4, the UAV 400 includes a barometer 401 and a processor 402. The barometer 401 and the processor 402 can be connected through a bus communication. The processor 402 may include a central processing unit (CPU), a general-purpose processor, a digital signal processor (DSP), an application specific integrated circuit (ASIC), a Field-Programmable Gate Array (FPGA) or other programmable logic devices, discrete gates or transistor logic devices, discrete hardware components, and the like. The general-purpose processor may include a microprocessor, any conventional processor, or the like.

The barometer 401 can be configured to detect a flight height of the UAV 400.

The processor 402 can be configured to, in response to a change of a motion state of the UAV 400, obtain a flight speed of the UAV 400, according to the predetermined corresponding relationship between the flight speeds and flight height compensation values, determine a flight height compensation value corresponding to the flight speed of the UAV 400, during a process of the change of the motion state of the UAV 400, compensate the flight height detected by the barometer 401 of the UAV 400 according to the flight height compensation value.

In some embodiments, before according to the predetermined corresponding relationship between the flight speeds and flight height compensation values, determining the flight height compensation value corresponding to the flight speed of the UAV 400, the processor 402 can be further configured to select the N selected flight speeds from a minimum flight speed to a maximum flight speed of the UAV 400. N is an integer greater than 1.

The processor 402 can be further configured to, for each selected flight speed of the N selected flight speeds, control the UAV 400 to fly at the selected flight speed, control the UAV 400 to change its motion state during the process of the UAV 400 flying at the selected flight speed, when the motion state of the UAV 400 changes, obtain a first flight height through a height sensor on the UAV 400 and a second flight height through the barometer 401 in the UAV 400, and obtain the flight height compensation value corresponding to the selected flight speed according to the first flight height and the second flight height.

The processor 402 can be further configured to, according to the N selected flight speeds and the flight height compensation values corresponding to the N selected flight speeds, obtain the predetermined corresponding relationship between the flight speeds and the flight height compensation values.

In some embodiments, the processor 402 can be further configured to perform the fitting processing on the N selected flight speeds and the flight height compensation values corresponding to the N selected flight speeds to obtain the corresponding relationship between the flight speeds and the flight height compensation values.

In some embodiments, the processor 402 can be further configured to, for every two adjacent selected flight speeds among the N selected flight speeds, perform the linear interpolation processing according to the two adjacent selected flight speeds and the two height compensation values corresponding to the two adjacent selected flight speeds to obtain the corresponding relationship between the two adjacent selected flight speeds and height compensation values, and according to the corresponding relationship between every two adjacent selected flight speeds among the N selected flight speeds and the flight height compensation values, obtain the predetermined corresponding relationship between the flight speeds and the flight height compensation values.

In some embodiments, the processor 402 can be further configured to divide a speed interval of the minimum flight speed to the maximum flight speed into N flight speed segments, and obtain the N selected flight speeds by selecting one selected flight speed from each flight speed segment.

In some embodiments, the predetermined corresponding relationship between the flight speeds and the flight height compensation values can include the predetermined corresponding relationship between the magnitudes of the flight speeds and the flight height compensation values in each of four preset flight directions. The four preset flight directions can include a front direction relative to a nose, a rear direction relative to the nose, a left direction relative to the nose, and a right direction relative to the nose of the UAV 400.

In some embodiments, the processor 402 can be further configured to, during the process of the change of the motion state of the UAV 400, superimpose the product of the flight height compensation value and the flight height compensation coefficient to the flight height detected by the barometer 401 to obtain the compensated flight height.

In some embodiments, the processor 402 can be further configured to, during the process of the change of the motion state of the UAV 400, determine the flight height compensation coefficient according to the duration of the change of the motion state of the UAV 400, and superimpose the product of the flight height compensation value and the flight height compensation coefficient on the flight height detected by the barometer 401 to obtain the compensated flight height.

In some embodiments, the processor 402 can be further configured to, during the early period of the duration when the motion state of the UAV 400 changes, superimpose the product of the first flight height compensation coefficient and the flight height compensation value on the flight height detected by the barometer 402 to obtain the compensated flight height, and during the later period of the duration when the motion state of the UAV 400 changes, superimpose the product of the second flight height compensation coefficient and the flight height compensation value on the flight height detected by the barometer 401 to obtain the compensated flight height. The first flight height compensation coefficient can be different from the second flight height compensation coefficient.

In some embodiments, the flight speed can include the flight speed before the motion state of the UAV 400 changes.

In some embodiments, the flight speed can include the flight speed after the motion state of the UAV 400 changes.

In some embodiments, the flight speed may include the direction of the flight speed and the magnitude of the flight speed.

In some embodiments, the processor 402 can be further configured to, in response to the motion state of the UAV 400 stopping changing, stop the compensation for the flight height detected by the barometer 401.

In some embodiments, the UAV 400 may further include a memory (not shown in FIG. 4). The memory can store codes for executing the compensation method for barometer-based height measurement consistent with the disclosure (e.g., the compensation method for barometer-based height measurement in FIG. 2). When the codes are called, the processes in the compensation method for barometer-based height measurement can be implemented.

The UAV consistent with the disclosure can be used to implement the technical solutions in the example methods described above, and its implementation principles and technical effects are similar to the methods, and detailed description thereof will be omitted herein.

Some or all of the processes in the example methods can be implemented by a program instructing relevant hardware. The program may be stored in a computer readable storage medium, and when being executed, the processes of the example methods can be implemented. The storage medium can include a read-only memory (ROM), a random access memory (RAM), a magnetic disk or an optical disk, or another medium that can store program codes.

The embodiments of the present disclosure are merely for illustrative purposes, and are not intended to limit the scope of the present disclosure. Those skilled in the art can modify the technical solutions described in the embodiments, or replace equivalently some or all of the technical features. These alterations and modifications should fall within the scope of the present disclosure.

What is claimed is:

1. A compensation method for barometer-based height measurement comprising:
obtaining a flight speed of an unmanned aerial vehicle (UAV) in response to a change of a motion state of the UAV;
determining a flight height compensation value corresponding to the flight speed of the UAV according to a predetermined corresponding relationship between flight speeds and flight height compensation values; and
during a process of changing the motion state, compensating a flight height detected by a barometer of the UAV according to the flight height compensation value.

2. The method of claim 1, further comprising, before determining the flight height compensation value corresponding to the flight speed of the UAV:
selecting N selected flight speeds from a speed interval of a minimum flight speed to a maximum flight speed of the UAV, N being an integer greater than 1;
for each selected flight speed of the N selected flight speeds:
controlling the UAV to fly at the selected flight speed;
controlling the UAV to change the motion state during a process of flying at the selected flight speed;
during a process of changing the motion state of the UAV, obtaining a first flight height through a height sensor of the UAV and a second flight height through the barometer of the UAV; and
obtaining a flight height compensation value corresponding to the selected flight speed according to the first flight height and the second flight height; and
obtaining the predetermined corresponding relationship according to the N selected flight speeds and the flight height compensation values corresponding to the N selected flight speeds.

3. The method of claim 2, wherein obtaining the predetermined corresponding relationship includes:
performing fitting processing on the N selected flight speeds and the flight height compensation values corresponding to the N selected flight speeds to obtain the corresponding relationship.

4. The method of claim 2, wherein selecting the N selected flight speeds from the speed interval includes:
dividing the speed interval into N flight speed segments; and
obtaining the N selected flight speeds by selecting one selected flight speed from each flight speed segment.

5. The method of claim 1, wherein the predetermined corresponding relationship includes:
a predetermined corresponding relationship between magnitudes of flight speeds and flight height compensation values in each of four preset flight directions, the four preset flight directions including a front direction relative to a nose of the UAV, a rear direction relative to the nose, a left direction relative to the nose, and a right direction relative to the nose.

6. The method of claim 1, wherein compensating the flight height detected by the barometer includes:
superimposing a product of the flight height compensation value and a flight height compensation coefficient to the flight height detected by the barometer to obtain a compensated flight height.

7. The method of claim 6, wherein compensating the flight height detected by the barometer further includes:
determining the flight height compensation coefficient according to a duration of the change of the motion state of the UAV.

8. The method of claim 1, wherein the flight speed includes a flight speed before the motion state of the UAV changes.

9. The method of claim 8, wherein the flight speed further includes a flight speed after the motion state of the UAV changes.

10. The method of claim 1, further comprising:
stopping compensating for the flight height detected by the barometer in response to the motion state of the UAV stopping changing.

11. An unmanned aerial vehicle (UAV) comprising:
a barometer configured to detect a flight height of the UAV; and
a processor configured to:
obtain a flight speed of the UAV in response to a change of a motion state of the UAV;
determine a flight height compensation value corresponding to the flight speed of the UAV according to a predetermined corresponding relationship between flight speeds and the height compensation values; and
during a process of changing the motion state, compensate the flight height detected by the barometer according to the flight height compensation value.

12. The UAV of claim 11, wherein the processor is further configured to, before determining the flight height compensation value corresponding to the flight speed of the UAV:
select N selected flight speeds from a speed interval of a minimum flight speed to a maximum flight speed of the UAV, N being an integer greater than 1;
for each selected flight speed of the N selected flight speeds:
control the UAV to fly at the selected flight speed;
control the UAV to change the motion state during a process of flying at the selected flight speed;
during a process of changing the motion state of the UAV, obtain a first flight height through a height sensor of the UAV and a second flight height through the barometer; and
obtain a flight height compensation value corresponding to the selected flight speed according to the first flight height and the second flight height; and
obtain the predetermined corresponding relationship according to the N selected flight speeds and the flight height compensation values corresponding to the N selected flight speeds.

13. The UAV of claim 12, wherein the processor is further configured to:
perform fitting processing on the N selected flight speeds and the flight height compensation values corresponding to the N selected flight speeds to obtain the corresponding relationship.

14. The UAV of claim 12, wherein the processor is further configured to:
divide the speed interval into N flight speed segments; and
obtain the N selected flight speeds by selecting one selected flight speed from each flight speed segment.

15. The UAV of claim 11, wherein the predetermined corresponding relationship includes:
a predetermined corresponding relationship between magnitudes of flight speeds and flight height compensation values in each of four preset flight directions, the four preset flight directions including a front direction relative to a nose of the UAV, a rear direction relative to the nose, a left direction relative to the nose, and a right direction relative to the nose.

16. The UAV of claim 11, wherein the processor is further configured to:
superimpose a product of the flight height compensation value and a flight height compensation coefficient to the flight height detected by the barometer to obtain a compensated flight height.

17. The UAV of claim 16, wherein the processor is further configured to:
determine the flight height compensation coefficient according to a duration of the change of the motion state of the UAV.

18. The UAV of claim 11, wherein the flight speed includes a flight speed before the motion state of the UAV changes.

19. The UAV of claim 18, wherein the flight speed further includes a flight speed after the motion state of the UAV changes.

20. The UAV of claim 11, wherein the processor is further configured to:
stop compensating for the flight height detected by the barometer in response to the motion state of the UAV stopping changing.
